(19) United States
(12) Patent Application Publication
(10) Pub. No.: US 2010/0151345 A1
(43) Pub. Date: Jun. 17, 2010

(54) Electrode Gas Channel Supports and Methods for Forming Internal Channels

(75) Inventors: James A. Salvatore, Sutton, MA (US); John Pietras, Sutton, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Saint-Gobain Ceramics & Plastics, Inc., Worcester, MA (US)

(21) Appl. No.: 12/638,769

(22) Filed: Dec. 15, 2009

Related U.S. Application Data
(60) Provisional application No. 61/203,085, filed on Dec. 17, 2008.

(51) Int. Cl. H01M 8/10; H01M 4/00

(52) U.S. Cl. 429/465; 429/495; 429/535

(57) ABSTRACT

A solid oxide fuel cell includes an anode layer, an electrolyte layer over the anode layer, and a cathode layer over the electrolyte layer, wherein at least one of the anode layer and the cathode layer defines at least one gas channel, the gas channel containing at least one support structure. The support structure can have a cross-sectional shape of an I-beam, an arch, a tube defining holes along its length, a porous cylinder, or a U-shaped brace. The support structure can be open at a portion of the gas channel most proximate to the electrolyte layer.

### RELATED APPLICATION

This application claims the benefit of U.S. Provisional Application No. 61/203,085, filed on Dec. 17, 2008.

The entire teachings of the above application are incorporated herein by reference.

### BACKGROUND OF THE INVENTION

A fuel cell is a device that generates electricity by a chemical reaction. Among various fuel cells, solid oxide fuel cells use a hard, ceramic compound metal (e.g., calcium or zirconium) oxide as an electrolyte. Typically, in solid oxide fuel cells, an oxygen gas, such as O₂, is reduced to oxygen ions (O²⁻) at the cathode, and a fuel gas, such as H₂ gas, is oxidized with the oxygen ions to form water at the anode. Fuel cells are generally designed as stacks, whereby subassemblies, each including a cathode, an anode and a solid electrolyte between the cathode and the anode, are assembled in series by locating an electrical interconnect between the cathode of one subassembly and the anode of another.

The efficiency of a solid oxide fuel cell (SOFC) depends in part on the distribution of oxygen and fuel in the cathode and anode, respectively. Gas delivery is typically provided to the SOFC stack by gas channels formed within the electrodes (cathode and anode). External access to the gas channels is typically provided by a manifold which acts as a conduit to supply fuel and oxygen into the gas channels. The gas channels can be green formed as voids in the electrode structure, or they can be green formed with a fugitive gas channel former that is subsequently removed during thermal processing. Additional thermal processing necessary to condition all layers of the solid oxide fuel cell to their desired properties can cause the collapse of the void space intended as a gas channel, leading to a reduction in oxygen or fuel delivery to the electrode and a consequent reduction in the efficiency of the fuel cell.

Therefore, there is a need for a new approach to the prevention of gas channel collapse.

### SUMMARY OF THE INVENTION

The invention generally is directed to solid oxide fuel cells and methods of forming solid oxide fuel cells that employ support structures within gas channels of the solid oxide fuel cell.

In one embodiment, the invention is a solid oxide fuel cell that includes an anode layer, an electrolyte layer over the anode layer, and a cathode layer over the electrolyte layer, wherein at least one of the anode layer and the cathode layer defines at least one gas channel, the gas channel containing at least one support structure. The anode layer or the cathode layer can be porous. The support structure can be essentially of the same composition as the respective cathode or anode. The support structure can be either nonporous or porous. Alternatively, the support structure can be of a different composition than the respective cathode or anode, and, either porous or nonporous. In other embodiments, the support structure can have a cross-sectional shape selected from the group consisting of an I-beam, an arch, a tube defining holes along its length, a porous cylinder, and a U-shaped brace. The support structure can be open at a portion of the channel most proximate to the electrolyte layer. The support structure can include a material selected from the group consisting of nickel, nickel oxide, yttria-stabilized zirconia, lanthanum strontium manganate, lanthanum strontium titanate, titanate, alumina, zirconia, and combinations thereof. Alternatively, the support structure can consist essentially of a material selected from the group consisting of yttria-stabilized zirconia, lanthanum strontium manganate, and lanthanum strontium titanate. The support structure can include at least one material selected from the group consisting of NiO, YSZ, Y₂O₃, Al₂O₃, LSM, LSF, LSCF, and titanates containing cations such as Ba, Ca, Sr, and Y. In one embodiment, the support structure substantially fills the gas channel. In another embodiment, both the anode layer and the cathode layer define channels that include support structures.

In another embodiment, the invention is a solid oxide fuel cell that includes an electrode formed by forming a green electrode layer that has a planar surface and defines at least one channel, wherein the green electrode layer includes pore formers proximate to the channel in a higher concentration of pore formers proximate to the channel than in the remainder of the green electrode, and sintering the green electrode to thereby form an electrode of a solid oxide fuel cell, whereby sintering of the green electrode causes at least the portion of the electrode proximate to the channels to be porous, and whereby the amount of the pore formers proximate to the channels is sufficient to cause dimensions of the electrode proximate to the channels to diminish more than remaining portions of the electrode during sintering, causing at least a portion of the planar surface of the electrode proximate to a relatively high concentration of pore formers to recede from a major plane of the planar surface.

In one embodiment, the invention is directed to a method of forming an electrode of a solid oxide fuel cell that includes forming a green electrode layer that defines at least one channel, and sintering the green electrode to thereby form an electrode of a solid oxide fuel cell. The green electrode can include pore formers proximate to the channel. In another embodiment, the green electrode includes a higher concentration of pore formers proximate to the channel than in the remainder of the green electrode, whereby sintering of the green electrode causes at least the portion of the electrode proximate to the channels to be porous. The amount of the pore formers proximate to the channels can be sufficient to cause dimensions of the electrode proximate to the channels to diminish more than remaining portions of the electrode during sintering. In one embodiment, the green electrode has a planar surface, and the electrode can be sintered to cause at least a portion of the planar surface of the electrode proximate to a relatively high concentration of pore formers to recede from a major plane of the planar surface. In another embodiment, the channel can be a conduit that is completely defined by the electrode upon assembly of the fuel cell, or, alternatively, the channel is open on one side of the green electrode. The method can include the step of placing an overlying layer of electrode material over the channel wherein the overlying layer has a concentration of pore formers proximate to the channels higher than that of the remainder of the overlying layer. The channel can be open on one side of the electrode, and the method can include the step of placing an overlaying layer of electrode material over the open channel, the overlaying layer including a pore former, the pore former having a higher concentration proximate to the open channel than in the remainder of the overlaying layer. In one embodiment, the amount of pore formers and the amount of sintering in combination cause the overlaying layer to be porous at least proximate to the channels. In another embodiment, the amount of sintering is sufficient to cause at least a portion of the overlaying layer having a higher concentration of pore formers to recede from a major plane of a surface of the overlaying layer.

In yet another embodiment, the invention is directed to a stack of solid oxide fuel cells that includes a plurality of subcells, each subcell including an anode layer, an electrolyte layer over the anode layer, a cathode layer over the electrolyte layer, a first bonding layer at the cathode and distal to the electrolyte, an interconnect layer at the first bonding layer, and a second bonding layer at the interconnect layer and distal to the first bonding layer of a subcell of the stack and adjacent to the anode layer of an adjacent subcell of the stack, wherein at least one of the anode layer and the cathode layer defines at least one gas channel, the gas channel containing at least one support structure.

An advantage of this invention is that the prevention of gas channel collapse by the use of support structures according to this invention raises the operational efficiency of solid oxide fuel cells due to higher fuel and oxygen gas flow rates through the respective electrodes of the cells. The present invention can be used in a solid oxide fuel cell (SOFC) system. SOFCs offer the potential of high efficiency electricity generation, with low emissions and low noise operation. They are also seen as offering a favorable combination of electrical efficiency, co-generation efficiency and fuel processing simplicity. One example of a use for SOFCs is in a home or other building. The SOFC can use the same fuel that is used to heat the home, such as natural gas. The SOFC system can run for extended periods of time to generate electricity to power the home and if excess amounts are generated, the excess can be sold to the electric grid. Also, the heat generated in the SOFC system can be used to provide hot water for the home. SOFCs can be particularly useful in areas where electric service is unreliable or non-existent.

### BRIEF DESCRIPTION OF THE DRAWINGS

FIG. 1 is a schematic diagram of a fuel cell of the invention.

FIG. 2A is a schematic diagram of fuel cell components of the invention, including an I-beam support structure.

FIG. 2B is a schematic diagram of fuel cell components of the invention, including an arch shaped support structure.

FIG. 2C is a schematic diagram of fuel cell components of the invention, including a U-shaped support structure.

FIG. 2D is a schematic diagram of fuel cell components of the invention, including a support structure that substantially fills a gas channel.

FIG. 2E is a schematic diagram of fuel cell components of the invention, including a support structure shaped as a tube defining holes along its length.

FIG. 2F is a schematic diagram of fuel cell components of the invention, including a support structure shaped as a porous tube.

FIG. 3 is a schematic diagram of a fuel cell stack of the invention.

FIG. 4 is an illustration of a solid oxide fuel cell component.

FIG. 5 is an illustration of a solid oxide fuel cell component that includes gas channels.

### DETAILED DESCRIPTION OF THE INVENTION

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention. The teachings of all patents, published applications and references cited herein are incorporated by reference in their entirety.

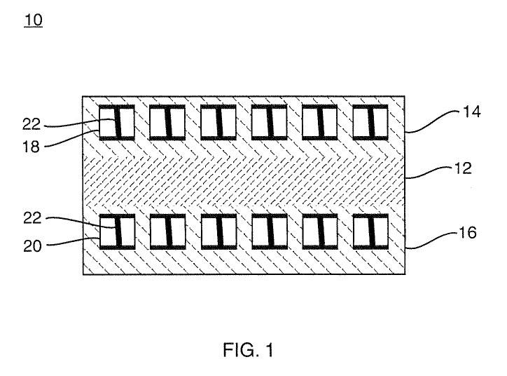

In one embodiment, the invention is a solid oxide fuel cell that includes an anode layer, an electrolyte layer over the anode layer, and a cathode layer over the electrolyte layer, wherein at least one of the anode layer and the cathode layer defines at least one gas channel, the gas channel containing at least one support structure. FIG. 1 shows fuel cell 10 of the invention. Fuel cell 10 includes electrolyte 12, anode 14, and cathode 16. Typically, anode 14 and cathode 16 electrodes are porous. In fuel cell 10, anode 14 at least in part defines at least one of first gas channels 18 in fluid communication with a fuel gas source, such as hydrogen (H₂) gas or natural gas which can be converted to H₂ gas in situ at anode 14. Cathode 16 at least in part defines at least one of second gas channels 20 in fluid communication with a source of oxygen gas, such as air. At least one set of gas channels 18 and second gas channels 20, and preferably both sets of gas channels, include support structures 22, shown as an I-beam. Support structures 22 can be essentially of the same composition as the respective cathode or anode, or support structures 22 can have a different composition. Support structures 22 can be either porous or nonporous.

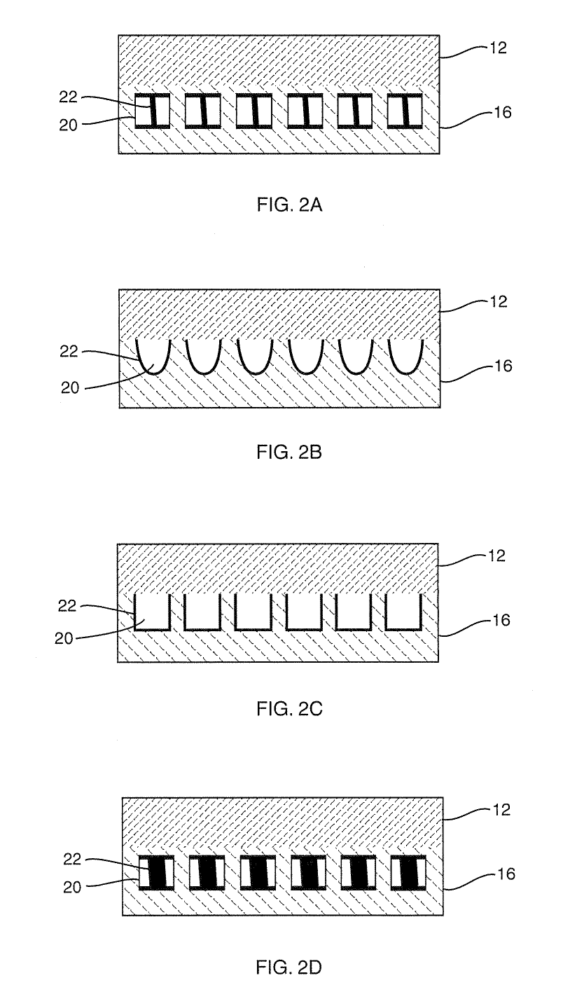

FIGS. 2A-F show example shapes for support structures 22, as an I-beam in FIG. 2A, an arch in FIG. 2B, a U-shaped brace in FIG. 2C, a tube defining holes along its length in FIG. 2E, and a porous cylinder in FIG. 2F. FIGS. 2A-D show only electrolyte 12 and support structures 22 formed within cathode 16 for clarity, but corresponding support structures 22 can also be formed within anode 14. Support structures 22 can substantially fill the gas channels, as shown in FIG. 2D. As illustrated in FIGS. 2B and 2C, support structures 22 can be open at a portion of the channel most proximate to electrolyte 12.

Any suitable anode materials known in the art can be used for anode 14, for example, in “High Temperature Solid Oxide Fuel Cells: Fundamentals, Design and Applications,” pp. 149-169, Dinghal, et al. Ed., Elsevier Ltd. (2003), the entire teachings of which are incorporated herein by reference. In one embodiment, anode 14 includes a nickel (Ni) cermet. As used herein, the phrase “Ni cermet” means a ceramic metal composite that includes Ni, such as about 20 wt %-70 wt % of Ni. Examples of Ni cermets are materials that include Ni, lanthanum strontium titanate (LST), and yttria-stabilized zirconia (YSZ), such as ZrO₂ containing about 15 wt % of Y₂O₃, and materials that include Ni and Y-zirconia or Sc-zirconia. An additional example of an anode material is cerium oxide. A specific example of an Ni cermet includes 67 wt % Ni and 33 wt % YSZ.

Any suitable cathode materials known in the art can be used for cathode 16, for example, in “High Temperature Solid Oxide Fuel Cells: Fundamentals, Design and Applications,” pp. 119-143, Dinghal, et al. Ed., Elsevier Ltd. (2003), the entire teachings of which are incorporated herein by reference. In one embodiment, cathode 16 includes a La-manganate (e.g, La₁₋ₐMnO₃, where “a” is equal to or greater than zero, and equal to or less than 0.1) or La-ferrite based material. Typically, the La-manganate or La-ferrite based material is doped with one or more suitable dopants, such as Sr, Ca, Ba, Mg, Ni, Co or Fe. Examples of doped La-manganate based materials include LaSr-manganates (LSM) (e.g., La₁₋ₖSrₖMnO₃, where k is equal to or greater than 0.1, and equal to or less than 0.3, (La+Sr)/Mn is in a range of between about 1.0 and about 0.95 (molar ratio)) and LaCa-manganates (e.g., La₁₋ₖCaₖMnO₃, k is equal to or greater than 0.1, and equal to or less than 0.3, (La+Ca)/Mn is in a range of between about 1.0 and about 0.95 (molar ratio)). Examples of doped La-ferrite based materials include LaSrCo-ferrite (LSCF) (e.g. La_{1-g}Sr_{q}Co₁₋ⱼFeⱼO₃, where each of q and j independently is equal to or greater than 0.1, and equal to or less than 0.4, (La+Sr)/(Fe+Co) is in a range of between about 1.0 and about 0.95 (molar ratio)). In one specific embodiment, cathode 16 includes at least one of a LaSr-manganate (LSM) (e.g., La₁₋ₖSrₖMnO₃) and a LaSrCo-ferrite (LSCF). Common examples include (La_{0.8}Sr_{0.2})_{0.98}MnO_{3±δ} (δ is equal to or greater than zero, and equal to or less than 0.3) and La_{0.6}Sr_{0.4}Co_{0.2}Fe_{0.8}O₃.

Typically, the thickness of each of anode and cathode electrodes 14 and 16 is, independently, in a range of between about 0.5 mm and about 2 mm. Specifically, the thickness of each of anode and cathode electrodes 14 and 16 is, independently, in a range of between about 1 mm and about 2 mm.

Solid electrolyte 12 is between anode 14 and cathode 16. Any suitable solid electrolytes known in the art can be used in the invention such as those described in “High Temperature Solid Oxide Fuel Cells: Fundamentals, Design and Applications,” pp. 83-112, Dinghal, et al. Ed., Elsevier Ltd. (2003), the entire teachings of which are incorporated herein by reference. Examples include YSZ, lanthanum strontium manganate (LSM), ZrO₂ based materials, such as Sc₂O₃-doped ZrO₂, Y₂O₃-doped ZrO₂, and Yb₂O₃-doped ZrO₂; CeO₂ based materials, such as Sm₂O₃-doped CeO₂, Gd₂O₃-doped CeO₂, Y₂O₃-doped CeO₂ and CaO-doped CeO₂; Ln-gallate based materials (Ln=a lanthanide, such as La, Pr, Nd or Sm), such as LaGaO₃ doped with Ca, Sr, Ba, Mg, Co, Ni, Fe or a mixture thereof (e.g., La_{0.8}Sr_{0.2}Ga_{0.8}Mg_{0.2}O₃, La_{0.8}Sr_{0.2}Ga_{0.8}Mg_{0.15}Co_{0.05}O₃, La_{0.9}Sr_{0.1}Ga_{0.8}Mg_{0.2}O₃, LaSrGaO₄, LaSrG₃O₇ or La_{0.9}A_{0.1}GaO₃ where A=Sr, Ca or Ba); and mixtures thereof. Other examples include doped yttrium-zirconate (e.g., YZr₂O₇), doped gadolinium-titanate (e.g., Gd₂Ti₂O₇) and brownmillerites (e.g., Ba₂In₂O₆ or Ba₂In₂O₅). In a specific embodiment, electrolyte 12 includes ZrO₂ doped with 8 mol % Y₂O₃ (i.e., 8 mol % Y₂O₃-doped ZrO₂.)

Typically, the thickness of solid electrolyte 12 is in a range of between about 5 μm and about 50 μm, such as between about 5 μm and about 20 μm, more preferably between about 5 μm and about 10 μm. Alternatively, the thickness of solid electrolyte 12 can be between about 20 μm and about 500, more preferably between about 100 μm and about 500 μm. In an embodiment employing solid electrolyte 12 having a thickness greater than about 100 μm, solid electrolyte 12 can provide structural support for fuel cell 10.

In one embodiment, support structure 22 includes a material selected from the group consisting of nickel, nickel oxide, yttria-stabilized zirconia, lanthanum strontium manganate, lanthanum strontium titanate, titanate, alumina, zirconia, and combinations thereof. In another embodiment, the support structure consists essentially of a material selected from the group consisting of nickel, nickel oxide, yttria-stabilized zirconia, lanthanum strontium manganate, lanthanum strontium titanate, titanate, alumina, zirconia, and combinations thereof. Alternatively, support structures 22 can include at least one material selected from the group consisting of nickel oxide (NiO), yttria-stabilized zirconia (YSZ), yttria (Y₂O₃), alumina (Al₂O₃), lanthanum strontium manganate (LSM), lanthanum strontium ferrite (LSF), lanthanum strontium cobaltite ferrite (LSCF), and titanates containing cations such as Ba, Ca, Sr, and Y. The support structure can be of the same material as the corresponding cathode or anode material described above.

In another embodiment, the invention is a solid oxide fuel cell that includes an electrode formed by forming a green electrode layer that has a planar surface and defines at least one channel, wherein the green electrode layer includes pore formers proximate to the channel in a higher concentration of pore formers proximate to the channel than in the remainder of the green electrode, and sintering the green electrode to thereby form an electrode of a solid oxide fuel cell, whereby sintering of the green electrode causes at least the portion of the electrode proximate to the channels to be porous, and whereby the amount of the pore formers proximate to the channels is sufficient to cause dimensions of the electrode proximate to the channels to diminish more than remaining portions of the electrode during sintering, causing at least a portion of the planar surface of the electrode proximate to a relatively high concentration of pore formers to recede from a major plane of the planar surface. Pore formers can include, for example, graphite powder.

In one embodiment, the invention is directed to a method of forming an electrode of a solid oxide fuel cell that includes forming a green electrode layer that defines at least one channel, and sintering the green electrode to thereby form an electrode of a solid oxide fuel cell. The green electrode can include pore formers proximate to the channel. Pore formers can include, for example, graphite powder. In another embodiment, the green electrode includes a higher concentration of pore formers proximate to the channel than in the remainder of the green electrode, whereby sintering of the green electrode causes at least the portion of the electrode proximate to the channels to be porous. The amount of the pore formers proximate to the channels can be sufficient to cause dimensions of the electrode proximate to the channels to diminish more than remaining portions of the electrode during sintering. In one embodiment, the green electrode has a planar surface, and the electrode can be sintered to cause at least a portion of the planar surface of the electrode proximate to a relatively high concentration of pore formers to recede from a major plane of the planar surface. In another embodiment, the channel can be a conduit that is completely defined by the electrode upon assembly of the fuel cell, or, alternatively, the channel is open on one side of the green electrode. The method can include the step of placing an overlying layer of electrode material over the channel wherein the overlying layer has a concentration of pore formers proximate to the channels higher than that of the remainder of the overlying layer. The channel can be open on one side of the electrode, and the method can include the step of placing an overlaying layer of electrode material over the open channel, the overlaying layer including a pore former, the pore former having a higher concentration proximate to the open channel that in the remainder of the overlaying layer. In one embodiment, the amount of pore formers and the amount of sintering in combination cause the overlaying layer to be porous at least proximate to the channels. In another embodiment, the amount of sintering is sufficient to cause at least a portion of the overlaying layer having a higher concentration of pore formers to recede from a major plane of a surface of the overlaying layer.

In another embodiment, the invention is directed to a method of forming a solid oxide fuel cell precursor, comprising the step of bisque-firing a green anode layer or green cathode layer, wherein the green anode layer or green cathode layer defines a channel. A support can be within the channel of the green anode or green cathode layer. The support structure can be porous. The support structure can be of a fugitive material, whereby the support structure dissipates during bisque-firing of the green anode or green cathode layer, or the support structure can be removed by dissolution or sublimation, or the support structure can be physically removed. Alternatively, the channel can be made without supports, the step of bisque-firing creating the support structure.

There exists a variety of possible materials that can be used to form the channels or passageways within the cathode and anode layers, such as, for example, fibers. Generally, the only limitations on the selection of materials would be that the material would burn or be out-gassed from the fuel cell during the firing process, and that the material is not reactive with the ceramic particles. These two conditions are adequately satisfied by organic based materials. Thus, the fibers can be natural fibers; cotton, bast fibers, cordage fibers, or animal fibers, such as wool, or they may be manufactured fibers; regenerated cellulose, cellulose diacetate, cellulose triacetate, polyamide, polyester, polyacrylic, polyvinyl, polyolefin resins, carbon or graphite fibers, or liquid crystal polymers. Alternatively, the fibers can be extruded lengths of binder material such as synthetic rubber, thermoplastics, or polyvinyl and extruded lengths of plasticizer material such as glycol and phthalate groups. In another embodiment, the material can be pasta, such as spaghetti. Examples of fugitive materials suitable for removal by dissolution or sublimation include camphene (bicyclic monoterpene) and ice (H₂O). Bisque-firing can include heat treatment in an air atmosphere at a temperature in the range of about 1200° C. to about 1500° C., preferably at about 1350° C. The channels can be straight, or they can define non-linear paths in a plane or in three dimensions.

The support structure can have a cross-sectional shape selected from the group consisting of an I-beam, an arch, a tube defining holes along its length, a porous tube, a porous cylinder, and a U-shaped brace. The support structure can be open at a portion of the channel most proximate to the electrolyte layer. In one embodiment, the support structure includes a material selected from the group consisting of nickel, nickel oxide, yttria-stabilized zirconia, lanthanum strontium manganate, lanthanum strontium titanate, titanate, alumina, zirconia, and combinations thereof. In another embodiment, the support structure consists essentially of a material selected from the group consisting of nickel, nickel oxide, yttria-stabilized zirconia, lanthanum strontium manganate, lanthanum strontium titanate, titanate, alumina, zirconia, and combinations thereof. The support structure can be of the same material as the corresponding cathode or anode material. In one embodiment, the support structure substantially fills the gas channel. The support structure can include at least one material selected from the group consisting of NiO, YSZ, Y₂O₃, Al₂O₃, LSM, LSF, LSCF, and titanates containing cations such as Ba, Ca, Sr, and Y. Alternatively, the support structure can include a blend of NiO, YSZ, Y₂O₃, Al₂O₃, LSM, LSF, LSCF, and titanates containing cations such as Ba, Ca, Sr, and Y. In another embodiment, both the anode layer and the cathode layer define channels that include support structures.

The method can include the steps of placing the bisque-fired layer over a green functional layer and firing the combined layers to form a cathode or anode having a channeled layer and a porous functional layer. In one embodiment, both a green cathode layer and a green anode layer are bisque-fired, and the method further includes the step of assembling a pre-sintered stack by a method that includes placing the bisque-fired anode layer over a green anode functional layer, and placing a bisque-fired cathode layer over a green cathode functional layer. In another embodiment, the method further includes the step of assembling a laminate that includes a bisque-fired anode layer and a green anode functional layer, a green electrolyte layer at the green anode functional layer, the bisque-fired cathode layer and green cathode functional layer at the green electrolyte layer, and an interconnect layer at the bisque-fired layer. The laminate can be fired to form a solid oxide fuel cell, or, alternatively, the method can further include the step of assembling at least two laminates and firing to form a stack of solid oxide fuel cells. The laminate can be fired sufficiently to cause the functional layers to be porous.

In one embodiment, the laminate can be hot-pressed. In another embodiment, a support structure can be within at least a portion of at least one channel. In one embodiment, the support structure is of a fugitive material, whereby the support structure dissipates during bisque-firing of the green anode or cathode layer. Examples of fugitive materials include graphite and graphite/polymer mixtures. In another embodiment, the support structure is removed by dissolution. In yet another embodiment, the support structure is removed by sublimation. Examples of fugitive materials suitable for removal by dissolution or sublimation include camphene (bicyclic monoterpene) and ice (H₂O).

In one embodiment, the support structure is physically removed. The support structure can have a cross-sectional shape selected from the group consisting of an I-beam, an arch, a tube defining holes along its length, a porous cylinder, and a U-shaped brace. In one embodiment, the support structure can be porous. In another embodiment, the support structure can be open at a portion of the channel most proximate to the electrolyte layer. In one embodiment, the support structure can include a material selected from the group consisting of nickel, nickel oxide, yttria-stabilized zirconia, lanthanum strontium manganate, lanthanum strontium titanate, titanate, alumina, zirconia, and combinations thereof. In another embodiment, the support structure can consist essentially of a material selected from the group consisting of nickel, nickel oxide, yttria-stabilized zirconia, lanthanum strontium manganate, lanthanum strontium titanate, titanate, alumina, zirconia, and combinations thereof. The support structure can be of the same material as the corresponding cathode or anode material. In one embodiment, the support structure substantially fills the gas channel. The support structure can include at least one material selected from the group consisting of NiO, YSZ, Y₂O₃, Al₂O₃, LSM, LSF, LSCF, and titanates containing cations such as Ba, Ca, Sr, and Y. Alternatively, the support structure can include a blend of NiO, YSZ, Y₂O₃, Al₂O₃, LSM, LSF, LSCF, and titanates containing cations such as Ba, Ca, Sr, and Y.

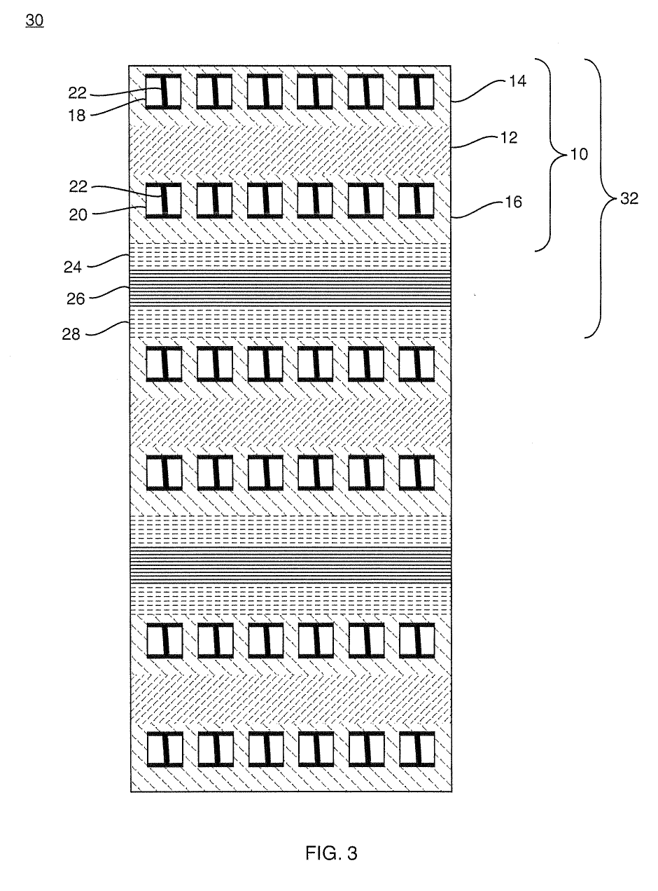

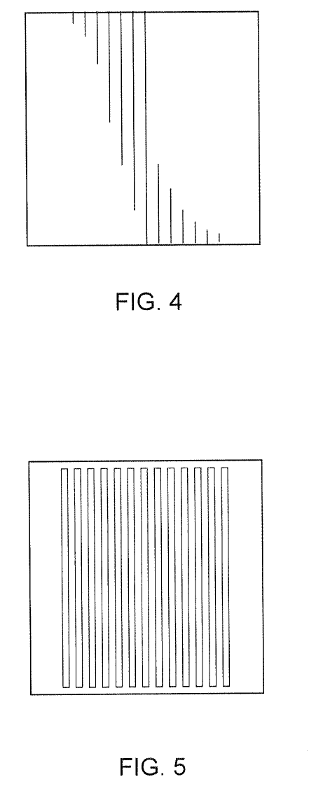

Support structures can be made by aqueous tape casting of slurries of anode and cathode powders. An acrylic based binder system (WB4101, Polymer Innovations, Inc., Vista, Calif.) can be used at a level of 10 wt % based on the dry powder. Sheets can be tape cast with a thickness of approximately 350 microns. In example embodiments, the tape cast sheets can then be cut into two configurations: solid squares with length and width dimensions of about 55 mm, shown in FIG. 4, and squares of equivalent external dimensions, but with material removed to create 13 parallel slits each with a width of about 1.3 mm and a length of about 50 mm, as shown in FIG. 5. Alternatively, a pattern can be embossed in two solid squares. The squares can then be stacked vertically with edges aligned to create an internal cavity. In one embodiment, two solid sheets of any suitable shape, such as, for example, square, rectangular, or oval shape can be placed together, followed by five channel cut sheets, effectively creating 13 depressions about 1.3 mm wide by about 1.4 mm deep. A fugitive rod (e.g., 1.3 mm diameter HB pencil lead from Pentel) can then be placed in each of the cavities produced within the stacked sheets. Then two solid sheets can be placed on top to cover the cavity. The stack of sheets can then be laminated together in a heated press at a temperature of about 300° F. and about 3,000 psi of pressure. The subsequently formed part can then be heat treated to remove binders and fugitive channel formers and to partially sinter the ceramic powders. An example of a thermal profile is listed in Table 1 below. The portion of the thermal profile from room temperature to 675° C. is used to remove the binders and fugitive channel former, while the remainder of the thermal profile improves the strength of the ceramic material.

TABLE 1
Thermal profile (° C.) for forming gas channels

| | |
|---|---|
| Hold | Segment |

| Segment | C/min | Time (min) | hr | min | Temp |
|---|---|---|---|---|---|
| Start | | | | | 20 |
| 1 | 1 | | 3 | 50 | 250 |
| 2 | | 180 | 3 | 0 | 250 |
| 3 | 0.5 | | 3 | 20 | 350 |
| 4 | | 0 | 0 | 0 | 350 |
| 5 | 1 | | 5 | 0 | 650 |
| 6 | | 120 | 2 | 0 | 650 |
| 7 | 1 | | 0 | 25 | 675 |
| 8 | | 60 | 1 | 0 | 675 |
| 9 | 5 | | 2 | 25 | 1450 |
| 10 | | 60 | 1 | 0 | 1450 |
| 11 | 15 | | 1 | 33 | 50 |
| 12 | | 0 | 0 | 0 | 50 |

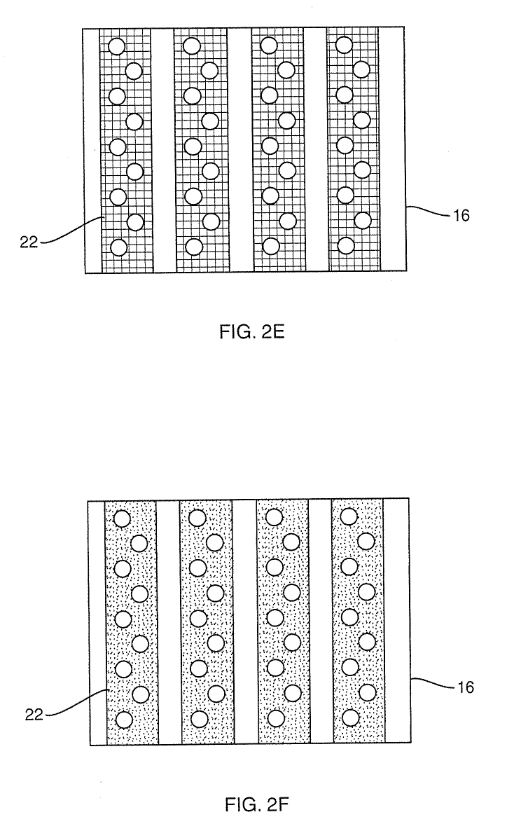

In yet another embodiment, the invention is directed to a stack of solid oxide fuel cells that includes a plurality of subcells, each subcell including an anode layer, an electrolyte layer over the anode layer, a cathode layer over the electrolyte layer, a first bonding layer at the cathode and distal to the electrolyte, an interconnect layer at the first bonding layer, and a second bonding layer at the interconnect layer and distal to the first bonding layer of a subcell of the stack and adjacent to the anode layer of an adjacent subcell of the stack, wherein at least one of the anode layer and the cathode layer defines at least one gas channel, the gas channel containing at least one support structure. FIG. 3 shows a stack 30 of solid oxide fuel cells 10 that includes a plurality of subcells 32, each subcell 32 including anode layer 14, electrolyte layer 12 over anode layer 14, cathode layer 16 over electrolyte layer 12, first bonding layer 24 at cathode layer 16 and distal to electrolyte layer 12, interconnect layer 26 at first bonding layer 24, and second bonding layer 28 at interconnect layer 26 and distal to first bonding layer 24 of a subcell 32 of stack 30, wherein at least one electrode, and preferably both anode layer 14 and cathode layer 16 define at least one gas channel 18, containing at least one support structure 22.

Fuel cell stack 30 further includes interconnect 26 between cells 10. Any material known to be suitable for use as an interconnect layer can be employed. An example of a suitable interconnect layer is one formed of chromium, and may further include rare earth elements, such as doped rare earth chromites. In one embodiment, interconnect layer 26 includes at least one of lanthanum, strontium, calcium, cobalt, gallium, yttria, titanate and magnesium. In other particular embodiments, the interconnect layer can include ceramics, such as LaSrCrO₃, LaMgCrO₃, LaCaCrO₃, YCrO₃, LaCrO₃, LaCoO₃, CaCrO₃, CaCoO₃, LaNiO₃, LaCrO₃, CaNiO₃ and CaCrO₃. In another embodiment, interconnect 26 can include two layers, as described in U.S. patent application Ser. No. 12/005,656, filed Dec. 27, 2007, entitled, “Bilayer Interconnects For Solid Oxide Fuel Cells,” the entire teachings of which are incorporated herein by reference.

The compositions of first bonding layer 24 and second bonding layer 28 can be distinct from each other in any given embodiment. Examples of suitable first bonding layers include those that include LSM, lanthanum cerium manganate, and lanthanum strontium nickel. Examples of suitable second bonding layers include those that include nickel-YSZ, nickel-LST, nickel felt, and nickel mesh.

### Exemplification

Bulk anode and cathode materials containing pyrolizable channel formers were bisque fired to about 1350° C. for about one hr to create a gas channel support region. These regions were then placed above and below a tri-layer laminate containing an anode functional layer, an electrolyte and a cathode functional layer. The entire cell was then heat treated to sufficiently bond the pre-sintered electrodes to the rest of the cell and to sinter the electrolyte to greater than about 95% of the theoretical density. The size of the average gas channel opening is given in Table 2 below along with those for a sample produced using standard processing without a gas channel support region. The use of the disclosed process resulted in significantly larger gas channels without affecting the area specific resistance (ASR) of the cell. This is significant in that the process of bonding the bisque fired electrode components to the unfired components did not induce a contact resistance. In addition, the increase in open area resulted in a much lower back pressure during electrochemical testing.

TABLE 2

| | | | | Cathode | Anode |
|---|---|---|---|---|---|
| | Cathode | Anode | ASR | Back- | Back- |
| | Channels | Channels | (Ohm | pressure | pressure |
| Concept | (mm²) | (mm²) | cm²) | (psi) | (psi) |
| Standard Process | 0.1 | 0.2 | 0.6 | 1.2 | 0.3 |
| Disclosed Process | 0.7 | 0.8 | 0.6 | 0.3 | 0.1 |

### Equivalents

While this invention has been particularly shown and described with references to example embodiments thereof, it will be understood by those skilled in the art that various changes in form and details may be made therein without departing from the scope of the invention encompassed by the appended claims.

What is claimed is:

1. A solid oxide fuel cell, comprising:
a) an anode layer;
b) an electrolyte layer over the anode layer; and
c) a cathode layer over the electrolyte layer,
wherein at least one of the anode layer and the cathode layer defines at least one gas channel, the gas channel containing at least one support structure.

2. The solid oxide fuel cell of claim 1, wherein the anode layer or the cathode layer is porous.

3. The solid oxide fuel cell of claim 1, wherein the support structure is porous.

4. The solid oxide fuel cell of claim 1, wherein the support structure is of a different composition than the respective cathode or anode.

5. The solid oxide fuel cell of claim 4, wherein the support structure has a cross-sectional shape selected from the group consisting of an I-beam, an arch, a tube defining holes along its length, a porous cylinder, and a U-shaped brace.

6. The solid oxide fuel cell of claim 5, wherein the structure is open at a portion of the channel most proximate to the electrolyte layer.

7. The solid oxide fuel cell of claim 5, wherein the support structure includes a material selected from the group consisting of nickel, nickel oxide, yttria-stabilized zirconia, lanthanum strontium manganate, lanthanum strontium titanate, titanate, alumina, zirconia, and combinations thereof.

8. The solid oxide fuel cell of claim 4, wherein the support structure substantially fills the gas channel.

9. The solid oxide fuel cell of claim 8, wherein the support structure includes at least one material selected from the group consisting of nickel oxide (NiO), yttria-stabilized zirconia (YSZ), yttria (Y₂O₃), alumina (Al₂O₃), lanthanum-strontium manganate (LSM), lanthanum strontium ferrite (LSF), lanthanum strontium cobaltite ferrite (LSCF), and titanates containing cations such as Ba, Ca, Sr, and Y.

10. The solid oxide fuel cell of claim 9, wherein the support structure includes a blend of NiO, YSZ, Y₂O₃, Al₂O₃, LSM, LSF, LSCF, and titanates containing cations such as Ba, Ca, Sr, and Y.

11. The solid oxide fuel cell of claim 1, wherein both the anode layer and the cathode layer define channels that include support structures.

12. A solid oxide fuel cell comprising an electrode formed by:
a) forming a green electrode layer that has a planar surface and defines at least one channel, wherein the green electrode layer includes pore formers proximate to the channel in a higher concentration of pore formers proximate to the channel than in the remainder of the green electrode; and
b) sintering the green electrode to thereby form an electrode of a solid oxide fuel cell, whereby sintering of the green electrode causes at least the portion of the electrode proximate to the channels to be porous, and whereby the amount of the pore formers proximate to the channels is sufficient to cause dimensions of the electrode proximate to the channels to diminish more than remaining portions of the electrode during sintering, causing at least a portion of the planar surface of the electrode proximate to a relatively high concentration of pore formers to recede from a major plane of the planar surface.

13. A method of forming an electrode of a solid oxide fuel cell, comprising the steps of:
a) forming a green electrode layer that defines at least one channel; and
b) sintering the green electrode to thereby form an electrode of a solid oxide fuel cell.

14. The method of claim 13, wherein the green electrode includes pore formers proximate to the channel.

15. The method of claim 14, wherein the green electrode includes a higher concentration of pore formers proximate to the channel than in the remainder of the green electrode, whereby sintering of the green electrode causes at least the portion of the electrode proximate to the channels to be porous.

16. The method of claim 15, wherein the amount of the pore formers proximate to the channels is sufficient to cause dimensions of the electrode proximate to the channels to diminish more than remaining portions of the electrode during sintering.

17. The method of claim 16, wherein the green electrode has a planar surface, and wherein the electrode is sintered to cause at least a portion of the planar surface of the electrode proximate to a relatively high concentration of pore formers to recede from a major plane of the planar surface.

18. The method of claim 17, wherein the channel is a conduit that is completely defined by the electrode upon assembly of the fuel cell.

19. The method of claim 17, wherein the channel is open, whereby the channel is open on one side of the green electrode.

20. The method of claim 19, further including the step of placing an overlying layer of electrode material over the channel wherein the overlying layer has a concentration of pore formers proximate to the channels higher than that of the remainder of the overlying layer.

21. The method of claim 13, wherein the channel is open on one side of the electrode, including the step of placing an overlaying layer of electrode material over the open channel, the overlaying layer including a pore former, the pore former having a higher concentration proximate to the open channel than in the remainder of the overlaying layer.

22. The method of claim 21, wherein the amount of pore formers and the amount of sintering in combination cause the overlaying layer to be porous at least proximate to the channels.

23. The method of claim 22, wherein the amount of sintering is sufficient to cause at least a portion of the overlaying layer having a higher concentration of pore formers to recede from a major plane of a surface of the overlaying layer.

24. A stack of solid oxide fuel cells that includes a plurality of subcells, each subcell comprising:
a) an anode layer;
b) an electrolyte layer over the anode layer;
c) a cathode layer over the electrolyte layer;
d) a first bonding layer at the cathode and distal to the electrolyte;
e) an interconnect layer at the first bonding layer; and
f) a second bonding layer at the interconnect layer and distal to the first bonding layer of a subcell of the stack and adjacent to the anode layer of an adjacent subcell of the stack,
wherein at least one of the anode layer and the cathode layer defines at least one gas channel, the gas channel containing at least one support structure.
